(19) United States
(12) Patent Application Publication
(10) Pub. No.: US 2004/0213715 A1
(43) Pub. Date: Oct. 28, 2004

(54) Selective recovery of precious metal(s)

(76) Inventors: Frank Paul Lucien, Gymea (AU); Kenneth Chung Keong Lee, South Turramurra (AU); Rueben Jasingam, Rosebery (AU); Tam Tran, West Pymble (AU)

Correspondence Address: MICHAEL BEST & FRIEDRICH, LLP, 100 E WISCONSIN AVENUE, MILWAUKEE, WI, 53202, US

(21) Appl. No.: 10/479,736

(22) PCT Filed: Jun. 7, 2002
(86) PCT No.: PCT/AU02/00740

(30) Foreign Application Priority Data
Jun. 7, 2001 (AU) PR 5526

(51) Int. Cl. B01F 1/00

(52) U.S. Cl. 423/40; 75/744; 29/403.3

(57) ABSTRACT

A process for the selective removal of a least a portion of at least one precious metal in the form of a metal-cyanide complex from an ion-exchange resin to which the precious metal and at least one base metal-cyanide complex are bound, wherein the at least one precious metal is eluted from the resing by contacting the resin with an eluent comprising at least one counter-ion contained in a solvent selected from an organic solvent or a combination of an organic solvent and an aqueous solvent.

### FIELD OF THE INVENTION

The present invention relates to the selective recovery of precious metal(s) (gold, silver, platinum and/or palladium) from base metal(s) (copper, zinc, iron, lead and/or tin). The present invention is particularly concerned with a method for the selective elution of cyanide complexes of precious metals over cyanide complexes of base metals from an ion-exchange resin to which these complexes are bound.

### BACKGROUND

Cyanidation is used in many processes for the recovery of precious metals. One example is the recovery of precious metals from ore bodies, tailings and other waste material generated from the breakdown of the parent material. A particular case in point is the recovery of gold from gold bearing ores.

Another example is in the production of electrical or electronic components, eg electrical circuit boards/components in which precious metals are used as electrical conductors. There is a significant wastage associated with the process of plating or depositing of precious metals onto substrates. Unused precious metals are typically recovered in rinse solutions in which they exist as water-soluble ions, e.g. a cyanide complex ion such as Au(CN)₂⁻.

Another potential use for cyanidation is in the recovery of precious metals from supported-metal catalysts. Such catalysts consist of a coating of, or incorporates, one or more metal species on an inert support such as carbon or alumina. After extended use, the catalyst becomes ineffective and needs to be replaced with fresh material. The recovery of the precious metals from the spent catalyst is advantageous economically.

We will now describe current cyanidation techniques with particular reference to the recovery of gold from ores, however, it will be clear that the process of the present invention has application for the selective recovery of precious metals in other cyanidation processes, including those discussed above.

Gold is usually present in very low concentrations in naturally occurring ores and in concentrates derived from such ores. To help maximize the efficiency of leaching, cyanide is typically added in excess of the stoichiometric amount required for leaching. The excess cyanide is required in part because cyanide typically reacts with other minerals, is oxidized or volatilises from the system.

Gold bearing ores commonly include at least one base metal such as copper, zinc or iron.

During the processing of gold ores by cyanidation, several cyanide-soluble minerals react with cyanide forming base metal cyanides, from weak complexes such as zinc cyanide to very strong stable cyanides such as ferri- and ferrocyanides.

Copper minerals eg azurite (Cu₃(CO₃)₂(OH)₂), malachite (Cu₂CO₃(OH)₂), cuprite(CuO₂), tenorite(CO₂), chalcocite (Cu₂S) and covellite (CuS) present in copper-gold ores are all very soluble and leach at high rate in dilute cyanide liquors. Other complex sulphides such as bornite (CuFe₅S₄) and chrysocolla (Cu₂H₂Si₂O₅(OH)₄) and particularly chalcopyrite (CuFeS₂) are less soluble during gold extraction. Such copper-gold ores have traditionally been difficult to treat economically because of the high costs associated with cyanide consumption during leaching and cyanide destruction during effluent treatment.

Other gold bearing ores may be relatively rich in a base metal other than copper, for example, zinc. It is again necessary to separate the gold from the base metal.

Following leaching, gold may be recovered by a number of processes, such as zinc cementation, carbon adsorption or ion-exchange resin adsorption.

The cyanide may be recovered for recycle by known methods such as AVR (acidification, volatilisation and re-neutralization), AFR (acidification, filtration and reneutralization), or MNR (Metaligeselshaft Natural Resources) processes, the Cyanisorb™ process, or the AugMENT™ process.

The AVR process has been of interest to gold processors for a long time. Processes based on ion-exchange resins and AVR circuits have the unique advantage of recovering cyanide to offset the cost of reagents used in these processes. The AVR circuit involves acidification of the cyanide liquors or slurrying to lower the pH from about 10 to about 3.5 to convert free cyanide and weak complexes (of Zn, Cd, Ni) to hydrogen cyanide for recycling.

A considerable amount of effort had been spent on improving the performance of AVR since its early development. It has been accepted in the industry as an option for treating moderate or strong cyanide liquors. However, copper will be precipitated as copper cyanide during the acidification stage.

The Cyanisorb™ process is described in several US patents (U.S. Pat. No. 4,994,243 and 5,078,977 and 5,254,153, the disclosures of which are incorporated herein by reference). This process is slightly different from the original AVR circuits in that clear solutions or slurries are processed at near neutral pH.

The MNR (or SART) process was developed by Metallgesellschaft Natural Resources (Germany) and involves the sulphidisation (using NaSH) and acidification (to less than pH 5) of copper/cyanide rich liquors to precipitate copper as synthetic chalcocite (Cu₂S). After filtration, the liquor is re-causticised to produce caustic cyanide or acidified further to form HCN gas and recovered via adsorption columns.

The AugMENT™ process relies on commercial strong-base resins for recovering and concentrating the copper cyanide. The resin is first impregnated with CuCN precipitate to produce an efficient adsorbent for free cyanide and soluble copper cyanides. After loading, the resin is then stripped with a copper cyanide/caustic eluant (10-70 g/L Cu, 10 g/L NaOH, total CN/Cu ratio of 3.5-4.0:1). Gold has to be recovered prior to copper electrowinning and cyanide recovery.

Processes based on ion-exchange resins have the unique advantage of recovering cyanide to offset the cost of reagents used in these processes. Resins have been used since the 1980s to recover gold from gold cyanide leach liquors in South Africa and earlier in the former USSR states. The earlier processes relied on basic eluants such as thiocyanate (SCN), chloride or hydroxide to remove gold cyanide from the loaded resin for further processing. However, where base metal cyanide complexes such as copper cyanide complexes are present in the liquor, sulphuric acid is also used to strip complexes off the resins. The acid elution employed in several of the latest processes destroys the cyanide complexes, regenerating cyanide for recycling via HCN gas.

While cyanidation processes involving the use of ion-exchange resins are generally advantageous for the recovery of precious metals, such processes are made more complicated when the material being treated contains one or more base metal that form soluble cyanide complexes. This complication is not only confronted when recovering gold from gold bearing ores containing base metals such as copper or zinc, as described above, but also occurs in any cyanidation process for the recovery of precious metals from material that also contains one or more base metals that form soluble cyanide complexes. It would be advantageous to have a process that allows for the selective recovery of one or more precious metals over one or more base metals.

We have discovered a process that provides selective recovery of at least one precious metal-cyanide complex over at least one base metal-cyanide complex from an ion-exchange resin to which these metal complexes are bound. This process involves selective elution of precious metal-cyanide complex(es) using an eluant comprising a counter-ion in a solvent selected from an organic solvent or a combination of an organic solvent and an aqueous solvent.

### DESCRIPTION OF THE INVENTION

Accordingly, in a first aspect, the present invention provides a process for the selective removal of a least a portion of at least one precious metal in the form of a precious metal-cyanide complex from an ion-exchange resin to which the precious metal and at least one base metal-cyanide complex are bound, wherein the at least one precious metal is eluted from the resin by contacting the resin with an eluent comprising at least one counter-ion contained in a solvent selected from an organic solvent or a combination of an organic solvent and an aqueous solvent.

The at least one precious metal may be selected from the group consisting of gold, silver, platinum, palladium and a combination of two of more thereof. Where more than one precious metal-cyanide complex is bound to the resin, the process of the invention will result in the selective elution of all the precious metal-cyanide complexes over the, or all, base metal-cyanide complex(es) bound to the ion-exchange resin.

The at least one base metal may be selected from the group consisting of copper, zinc, iron, lead, tin and a combination of two of more thereof.

The counter-ion is required to facilitate the elution of gold. The counter-ion may be any suitable ion that leads to selective stripping of gold over copper. Examples of suitable counter-ions include, but is not limited to, CN⁻, OH⁻, HSO₃⁻, HSO₄⁻, SCN⁻ and Cl⁻. The counter-ion may be incorporated into the solvent as its alkali metal salt (eg sodium salt).

The solvent should be of sufficient polarity for counter-ions to exist therein.

By the term “organic solvent” as used herein, we mean a single organic solvent or a mixture of two or more organic solvents. Some organic solvents (eg dimethyl sulfoxide (DMSO)) are of sufficient polarity for them to be used as the solvent in the process of the present invention. As mentioned, the organic solvent may be a mixture of two or more organic solvents, for example, the solvent could be a mixture of pure acetone and pure DMSO.

The solvent may comprise a combination of an organic solvent and an aqueous solvent. Preferably the organic solvent is a polar organic solvent that is soluble in water. Again, the organic solvent may be a single organic solvent or a mixture of two or more organic solvents. Particularly preferred organic solvents are those that are stable, particularly in aqueous solutions, and are relatively non-volatile and/or less flammable. The solvent may be a compound including a group of formula:

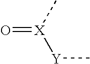

wherein:

X is selected from C, S or P;

Y is selected from C, N or O;

the dotted line ( - - - ) from X represents at least one chemical bond; and

the dotted line ( - - - ) from Y represents at least one chemical bond; or

the dotted lines from X and Y form part of an optionally substituted carbocyclic ring optionally interrupted by one or more heterocyclic atoms

The or each chemical bond from X may be to, for example, a carbon, oxygen or hydrogen.

The or each chemical bond from Y may be to, for example, a carbon or hydrogen.

Thus, for example, in the case of acetone, X=carbon and Y=carbon. X is also bonded to another C and Y is bonded to an additional 3 hydrogen atoms. The atoms bonded to X and Y may also be linked with other atoms to form rings as, for example, in the case of N-methyl-2-pyrrolidone.

Particular examples of organic solvents that may be used in the process of the invention include ketones (eg acetone, methyl ethyl ketone), amines (eg ethylamine, ethylenediamine, triethylamine), amides (eg formamide, diethylformamide, dimethylformamide, dimethylacetamide, diethylacetamide), sulfur-containing organic solvents (eg dimethylsulfoxide), nitriles (eg acetonitrile), phosphates (eg triethylphosphate, trimethylphosphate, tributylphosphate), heterocylic solvents (eg N-methyl-2-pyrrolidone, tetrahydrofuran dioxane, pyridine, dioxolane), alkoxy alkanes (eg dimethoxyethane), carbonates (eg propylene carbonate) and alcohols (eg methanol, ethanol).

Preferably, the organic solvent is a ketone or an amide.

The aqueous solvent may be water.

Where the solvent is a combination of an organic solvent and an aqueous solvent, the organic solvent is preferably present in the eluant in an amount of at least about 50 vol %, more preferably at least 60 vol %. Particularly preferred is an organic solvent content of about 60 to 95 vol % of the eluant composition.

The counter-ion may be present in the solvent at a concentration up to about 1 M. The concentration of counter-ion used depends on the type of ion. The optimum overall concentration for all types of ions may be much lower than 1 M, and in many instances may be 0.2M or less.

The resin may be any suitable ion-exchange resin. The resin may be an anion-exchange resin. Preferably, the ion-exchange resin is of the strong base anion type, for example, one having quaternary amine functionality, although other anion type resins are not excluded from the process of the present invention.

A variety of structural types may be used for the resin. A useful variety of resins have a macroporous resin bead structure based on polystyrene and polyurethane.

While the process of the present invention results in the elution of precious metal-cyanide complex(es) from the resin, the majority of base metal-cyanide complex(es) remain(s) adsorbed thereon. The remaining base metal-cyanide complex(es) may be eluted from the resin by contacting the resin with a separate aqueous solvent containing a counter-ion that results in the elution of base metal-cyanide complex(es).

Accordingly, in a second aspect, the present invention provides the process of the first aspect, wherein following the selective elution of the at least one precious metal-cyanide complex from the resin, the at least one base metal-cyanide complex is removed from the resin.

The base metal(s) may be removed from the resin using any technique known in the art. Preferably the base metal(s) is/are removed by elution with an aqueous solvent containing a counter-ion such as, for example, CN⁻, OH⁻, HSO₃⁻, HSO₄⁻, SCN⁻ and Cl⁻.

The precious metal-cyanide complex may be recovered from the eluant by any technique known in the art. One method is to use a precipitation technique in which either:

a) the eluant is evaporated; or

b) the eluant is cooled until saturation temperature of the eluant is reached.

In the case of (b), precipitation or crystallisation of the precious metal-cyanide complex occurs until the concentration of complex in the eluant reaches saturation value at the given temperature.

In other situations, however, it may not be practical to crystallise the precious metal-cyanide complex by cooling because excessively low temperature may be required. This may arise if the concentration of the precious metal-cyanide complex is not sufficiently high.

Compressed gas precipitation (CGP) may be used as an alternative to (a) and (b). Precipitation of the precious metal-cyanide complex may be achieved by contacting the eluant with a compressed gas. The dissolution of the compressed gas into the liquid eluant leads to volumetric expansion of the liquid phase, thus lowering its density and reducing its ability to maintain the precious metal-cyanide complex in solution. This leads to precipitation of the precious metal-cyanide complex.

Accordingly, in a third aspect, the present invention provides a process for the recovery of at least one precious metal-cyanide complex from an eluant comprising a counter-ion in an organic solvent, or in an organic solvent and an aqueous solvent, the method comprising contacting the eluant containing the precious metal-cyanide complex with a gas under conditions of pressure and temperature that result in the precipitation of at least part of the precious metal-cyanide complex.

The gas used in the CGP precipitation may be any suitable gas. The main requirement is that the gas must exhibit reasonable solubility in the eluant under conditions of elevated pressure. The condition of pressure in which precipitation can be achieved range from about 5 to 100 bar. The CGP process may be operated at a temperature in the range of about 10 to 50° C. The preferred gases are carbon dioxide, nitrous oxide, ethane, ethylene, propane, propylene and various chlorofluorohydrocarbons and mixtures thereof.

In a fourth aspect, the present invention provides a process of the first or second aspect further including recovery of at least part of the precious metal-cyanide complex from the eluant by the process of the third aspect of the invention.

In a fifth aspect, the present invention provides a process for the selective recovery of at least one precious metal in the form of a precious-cyanide complex from a mixture or composition containing at least one base metal, including;

(a) cyaniding the mixture or composition to produce a treated stream comprising cyanide complexes of the at least one precious metal and the at least one base metal;

(b) contacting at least part of the treated stream with an ion-exchange resin to adsorb at least part of the cyanide complexes;

(c) selectively eluting at least part of the at least one precious metal-cyanide complex from the resin of step (b) using an eluant comprising a counter-ion in a solvent selected from an organic solvent or an organic solvent and an aqueous solvent;

(d) optionally removing at least part of the at least one basic metal-cyanide complex from the resin of step (c); and

(e) optionally recovering the at least one precious metal from the eluted precious metal-cyanide complex.

The mixture or composition treated in the process of the fifth aspect of the invention may include one or more other precious metals.

The mixture or composition may be any material, including a liquid, containing at least one precious metal species and at least one basic metal species. It may be a recovered material eg a rinse solution recovered from waste material arising out of the production of electrical or electronic components, eg electrical circuit boards/components in which precious metals are used as electrical conductors. It may be a rinse solution from a process involving plating or depositing of precious metals onto substrates.

A further example of a material that may be treated using the process of the fifth aspect is precious metal-containing catalysts. Such catalysts consist of a coating of, or incorporates, one or more metal species on an inert support such as carbon or alumina. After extended use, the catalyst becomes ineffective and needs to be replaced with fresh material. The recovery of the precious metals from the spent catalyst is advantageous economically.

A particular embodiment of the process of the first aspect of the invention is the selective stripping (or elution) of adsorbed gold cyanide over base metal complexes such as copper or zinc cyanide complexes. This embodiment offers the possibility of faster elution of gold from resin and is highly selective for gold over base metals such as copper and zinc. This embodiment has particular application in the recovery of gold from gold bearing ores containing zinc and/or copper or the waste material resulting from the mechanical treatment of such an ore. In this case, the elution process of the fifth aspect of the invention may employ similar adsorption circuits to those used in conventional resin-in-pulp (RIP) or resin-in-column (RIC) operations for the separation of gold and other basemetals from leach solutions.

In the case of copper containing gold bearing ores, the copper may be present in the ore in the form of one or more of azurite (Cu₃(CO₃)₂(OH)₂), malachite (Cu₂CO₃(OH)₂), cuprite(CuO₂), tenorite(CO₂), chalcocite (Cu₂S), covellite (CuS), bornite (CuFe₅S₄), chrysocalla (Cu₂H₂Si₂O₅(OH)₄) and chalcopyrite (CuFeS₂).

The present invention also extends to precious metals recovered by use of a process in accordance with the present invention.

In order to provide a better understanding of the invention we provide the following non-limiting embodiments of the invention.

### BRIEF DESCRIPTION OF THE DRAWINGS

FIG. 1 is a graph showing the elution kinetics of gold at various acetone levels (Resin to Eluant 1:10 (by volume), concentration of cyanide 0.2M);

FIG. 2 is a graph showing a comparison of gold and copper elution with increasing acetone levels (Resin to Eluant 1:10 (by volume), concentration of cyanide 0.2M);

FIG. 3 is a graph showing the effect of NaCN concentration on gold elution;

FIG. 4 is a graph showing the effect of NaCN concentration on copper elution;

FIG. 5 is a graph showing the effect of NaOH concentration on elution of gold; and

FIG. 6 is a graph showing the elution of copper with thiocyanate.

Embodiments of the Invention

Experimental Details

Preliminary experiments were carried out on a model system to demonstrate the feasibility of the elution concept. For these experiments a bench-top scale was adopted, i.e. 1 to 10 ml resin samples were used. Purolite ion-exchange resin (A500 U/2788) which is a strong based anionic exchange resin, with a trimethyl-quaternary amine functional group was used as the adsorption media in these experiments. This type of resin is commercially available and is commonly used in water treatment.

To ensure the stability of the resin volume, it was presoaked in distilled water for at least 48 hours prior to metal adsorption. The resin was then loaded with Copper cyanide, gold cyanide and thiocyanate (typically desired loading was 20 kg/m³ Cu, 20 kg/m³ SCN and 5 kg/m³ Au) at room temperature and pressure by bottle rolling. The loading capacity was determined by head and tail solutions being analysed by atomic absorption spectroscopy (MS) for copper and gold, with thiocyanate determined by UV-VIS spectrophotometry using ASTM D 4193-95. Before the loaded resin was used in the elution experiments, it was washed with distilled water.

A series of equilibrium elution runs was then performed. A 10:1 eluant to resin ratio (volume basis) was used in the elution of the precious and base metals from the resin. The resin was placed in a conical flask (10 ml) followed by the eluant. The flasks were then placed on an orbital shaker at a constant temperature of 25° C. and a rotation speed of 200 orbits per minute. The rate of elution was monitored and 1 ml samples were taken off at 15, 30, 60, 120, 180 and 240 minutes. The samples were diluted to the appropriate concentrations and analyzed for copper, gold and thiocyanate.

Results and Discussions

1. The Effect of Acetone Levels in the Eluant on Gold and Copper Elution

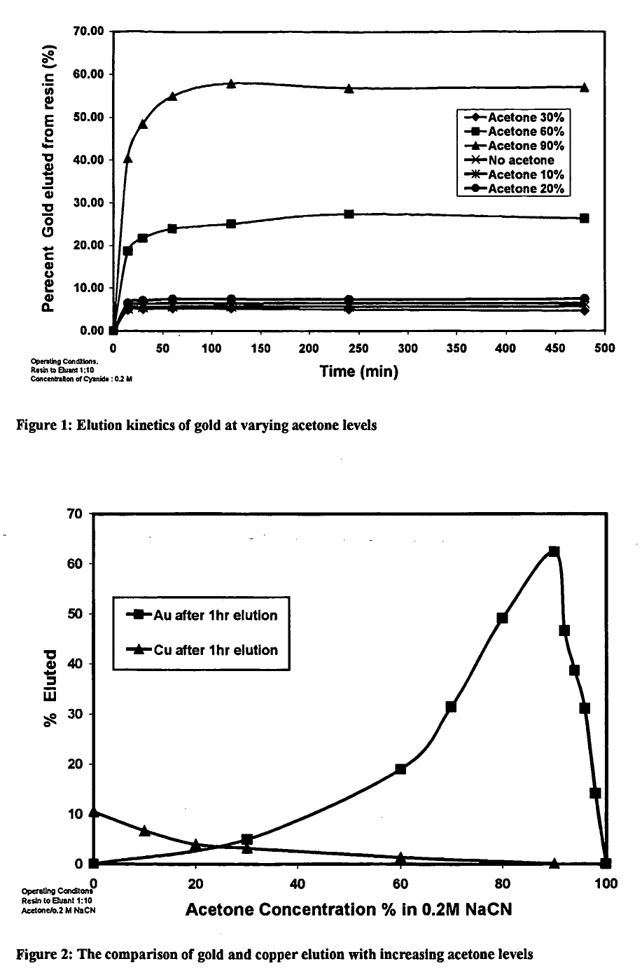

The results presented in FIG. 1 represent the equilibrium elution of gold using an eluant made up of varying ratios of acetone and 0.2M NaCN solution. It can be seen that at all acetone levels, equilibrium is reached after approximately 1 hour, indicating that rapid gold elution kinetics can be achieved.

As the acetone ratio in the eluant increases, the equilibrium elution of gold increases concurrently, reaching a maximum at a 90% (on a volume basis) acetone level. The equilibrium elution of copper on the other hand decreases as the acetone level in the eluant increases. FIG. 2 clearly indicates that good selectivity is achieved, with gold being favourably extracted over copper at acetone levels higher than 60%. Under the conditions of these experiments, an eluant consisting of 90% acetone, achieves the maximum elution of gold with almost no copper being eluted. Therefore a selectivity greater than 99% is achieved.

2. Effect of NaCN and NaOH Concentration on the Elution of Gold and Copper

Having established the effect of acetone levels on elution, experiments were carried out to investigate the effect of various anions (CN⁻ and OH⁻) and their concentrations on copper and gold elution at a fixed 90% level of acetone.

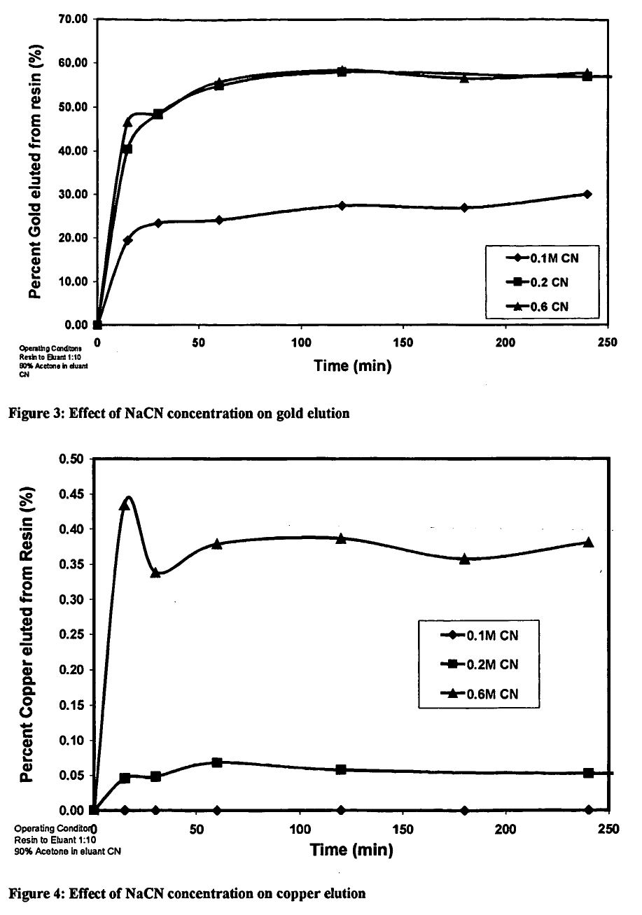

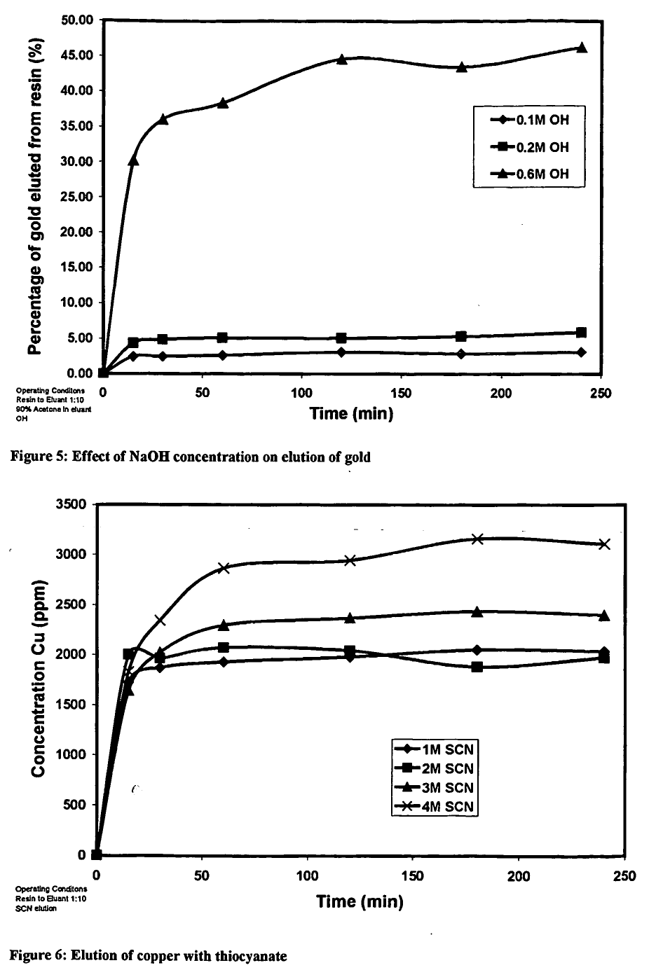

A certain amount of either NaOH or NaCN is required to facilitate the elution of gold. This is evident from the results depicted in FIGS. 3 and 5.

It is also observed that there is a maximum limit to which increasing the concentration of NaCN improves the elution of gold. FIG. 3 clearly shows that a NaCN concentration higher than 0.2M does not further improve the elution efficiency. However from FIG. 4 it is observed as the concentration of NaCN is increased, a corresponding increase in copper elution is observed. Therefore, in order to improve the selectivity of gold elution over copper, an optimum concentration of NaCN is required. Over the concentration range studied a concentration of approximately 0.2M NaCN provided the maximum gold elution and selectivity.

From the result depicted in FIG. 5, it can be concluded that NaOH can also be used in the eluant mixture to elute gold, however lower elution efficiencies were obtained in comparison with the use of NaCN. It was also observed that over the range of NaOH concentrations tested the amount of copper eluted was undetectable using MS analysis. Therefore it can be concluded that the use NaOH in conjunction with 90% acetone as an eluant is also selective for gold over copper.

3. Elution with SCN

After the selective elution of gold, the copper remaining on the resin is eluted. It was found that an eluant made up of thiocyanate successfully eluted copper reaching equilibrium in approximately 45 minutes, with a concentration of 2000 to 3000 ppm (FIG. 6). Under the same conditions, some gold was also observed to be eluted from the resin.

It will be appreciated by persons skilled in the art that numerous variations and/or modifications may be made to the invention as shown in the specific embodiments without departing from the spirit or scope of the invention as broadly described. For example, the particular embodiments have been described in reference to the recovery of gold from copper-gold ores. It will be clear however that the present invention has application has application to any process involving the use of cyanidation and an ion-exchange resin in the recovery from one or more precious metals from a material that also contains at least one base metal. The present embodiments are, therefore, to be considered in all respects as illustrative and not restrictive.

Throughout this specification the word “comprise”, or variations such as “comprises” or “comprising”, will be understood to imply the inclusion of a stated element, integer or step, or group of elements, integers or steps, but not the exclusion of any other element, integer or step, or group of elements, integers or steps.

Any discussion of documents, acts, materials, devices, articles or the like which has been included in the present specification is solely for the purpose of providing a context for the present invention. It is not to be taken as an admission that any or all of these matters form part of the prior art base or were common general knowledge in the field relevant to the present invention as it existed in Australia before the priority date of each claim of this application.

1. A process for the selective removal of a least a portion of at least one precious metal in the form of a precious metal-cyanide complex from an ion-exchange resin to which the precious metal and at least one base metalcyanide complex are bound, wherein the at least one precious metal is eluted from the resin by contacting the resin with an eluent comprising at least one counter-ion contained in a solvent selected from an organic solvent or a combination of an organic solvent and an aqueous solvent.

2. A process according to claim 1, wherein the one precious metal is selected from the group consisting of gold, silver, platinum, palladium and a combination of two of more thereof.

3. A process according to claim 1, wherein the at least one base metal is selected from the group consisting of copper, zinc, iron, lead, tin and a combination of two of more of thereof.

4. A process according to claim 1, wherein the counter-ion is selective for stripping gold over copper.

5. A process according to claim 4, wherein the counter-ion is selected from the group consisting of CN—, OH—, HSO₃—, HSO₄, SCN— and Cl—.

6. A process according to claim 1, wherein the counter-ion is in the form of an alkali metal salt.

7. A process according to any claim 1, wherein the organic solvent is a single organic solvent or a mixture of two or more organic solvents.

8. A process according to claim 1, wherein the organic solvent is a single solvent of sufficient polarity for the at least counter-ion to form therein.

9. A process according to claim 1, wherein the organic solvent is a mixture of two or more organic solvents.

10. A process according to claim 1, wherein the solvent is a combination of an organic solvent and an aqueous solvent.

11. A process according to claim 1, wherein the organic solvent is a polar organic solvent that is soluble in water.

12. A process according to claim 1, wherein the organic solvent is a compound including the group: 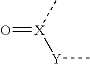
wherein:
X is selected from C, S or P;
Y is selected from C, N or 0;
the dotted line ( - - - ) from X represents at least one chemical bond; and
the dotted line ( - - - ) from Y represents at least one chemical bond; or
the dotted lines from X and Y form part of an optionally substituted carbocyclic ring optionally interrupted by one or more heterocyclic atoms.

13. A process according to claim 1, wherein the organic solvent is selected from one or more of the group consisting of a ketone, an organic amine, an organic nitrile, an organic phosphate, a heterocyclic solvent, an alkoxy alkane, sulfur-containing organic solvent, an organic carbonate, and an alcohol.

14. A process according to claim 13, wherein the solvent is selected from one or more of the group consisting of acetone, methyl ethyl ketone, ethylamine, ethylenediamine, triethylamine, formamide, diethylformamide, dimethylformamide, dimethylacetamide, diethylacetamide), dimethylsulfoxide, acetonitrile, triethylphosphate, trimethylphosphate, tributylphosphate, N-methyl-2-pyrrolidone, tetrahydrofuran dioxane, pyridine, dioxolane), dimethoxyethane, propylene carbonate, methanol and ethanol.

15. A process according to claim 1, wherein the solvent is selected from a ketone or an amide.

16. A method according to claim 1, wherein the solvent is a combination of an organic solvent and an aqueous solvent.

17. A process according to claim 1, wherein the aqueous solvent comprises water.

18. A process according to claim 16, wherein the solvent comprises the organic solvent in an amount of at least about 50 vol %.

19. A process according to claim 16, wherein the solvent comprises the organic solvent in amount of at least 60 vol %.

20. A process according to claim 16, wherein the organic solvent content is present in an amount of about 60 to 95 vol % of the eluent composition.

21. A process according to claim 1, wherein the counter-ion is present in the solvent at a concentration of up to about 1 M.

22. A process according to claim 1, wherein the counter-ion is present in a concentration of 0.2M or less.

23. A process according to claim 1, wherein the resin is an ion-exchange resin.

24. A process according to claim 1, wherein the resin is an anion-exchange resin.

25. A process according to claim 24, wherein the ion-exchange resin is of the strong base anion type.

26. A process according to claim 25, wherein the ion-exchange resin has quaternary amine functionality.

27. A process according to claim 1, wherein the resin has a macroporous resin bead structure.

28. A process according to claim 27, wherein the resin is based on polystyrene and polyurethane.

29. A process according to claim 1, wherein the precious metal is gold and optionally one or more other precious metal(s).

30. A process according to claim 1, further including the step of removing the at least one base metal-cyanide complex from the resin.

31. A process according to claim 30, wherein base metal-cyanide complex(es) present on the resin is/are eluted by contacting the resin with a separate aqueous solvent containing a counter-ion that results in the elution of base metal-cyanide complex(es).

32. A process according to claim 31, wherein the base metal(s) is/are removed by elution with an aqueous solvent containing a counter-ion.

33. A process according to claim 32, wherein the counter-ion is selected from the group consisting of CN—, OH—, HSO₃—, HSO₄—, SCN— and Cl—.

34. A process according to claim 1, wherein the precious metal is recovered from the eluant.

35. A process according to claim 34, wherein the precious metal is recovered by a precipitation of the precious metal.

36. A process according to claim 35, wherein the precious metal is precipitated by evaporation and/or cooling the eluant until saturation temperature of the eluant is reached.

37. A process according to claim 36, wherein the precious metal is precipitated by compressed gas precipitation (CGP).

38. A process for the selective recovery of at least one precious metal in the form of a precious-cyanide complex from a mixture or composition containing at least one base metal, comprising;
(a) cyaniding the mixture or composition to produce a treated stream comprising a cyanide complex(es) of the at least one precious metal and the at least one base metal;
(b) contacting at least part of the treated stream with an ion-exchange resin to adsorb at least part of the cyanide complex(es);
(c) selectively eluting at least part of the at least one precious metal-cyanide complex from the resin of step (b) using an eluant comprising a counter-ion in a solvent selected from an organic solvent or an organic solvent and an aqueous solvent;
(d) optionally removing at least part of the at least one basic metal-cyanide complex from the resin of step (c); and
(e) optionally recovering the at least one precious metal from the eluted precious metal-cyanide complex.

39. A process according to claim 38, wherein the mixture or composition comprises one or more other precious metals.

40. A process according to claim 38, wherein the mixture or composition is in liquid form.

41. A process according to claim 40, wherein the composition is a rinse solution.

42. A process according to claim 45, wherein the rinse solution is recovered from waste material.

43. A process according to claim 42, wherein the rinse solution results from the production of electrical or electronic component(s) or plating or depositing of precious metals onto substrate(s).

44. A process according to claim 38, wherein the mixture or composition is a precious metal-containing catalysts.

45. A process according to claim 1, when used for the selective stripping of adsorbed gold cyanide over a base metal complex(es).

46. A process according to claim 45, wherein the base metal complex is a copper or zinc cyanide complex.

47. A process according to claim 1, when used for the recovery of gold from a gold bearing ore body or tailing.

48. A process according to claim 1, when used in resin-in-pulp (RIP) or resin-in-column (RIC) operations for the separation of gold and other basemetals from a leach solution.

49. A process according to claim 38, when used to recover a precious metal from a copper containing gold bearing ore.

50. A process according to claim 49, wherein the copper is present in the ore in the form of one or more of azurite (CU₃(CO₃)₂(OH)₂), malachite (Cu₂CO₃(OH)₂), cuprite (CuO₂), tenorite (CO₂), chalcocite (Cu₂S), covellite (CuS), bornite (CuFe₅S₄), chrysocalla (Cu₂H₂Si₂O₅(OH)₄) and chalcopyrite (CuFeS₂).
